(19) United States
(12) Patent Application Publication
(10) Pub. No.: US 2022/0043414 A1
(43) Pub. Date: Feb. 10, 2022

(54) APPARATUS AND METHOD FOR OPERATING ENERGY STORAGE SYSTEM

(71) Applicant: Korea Advanced Institute of Science and Technology, Daejeon (KR)

(72) Inventors: Jun Kyun CHOI, Daejeon (KR); Jang Kyum KIM, Daejeon (KR); Sang Don PARK, Daejeon (KR); Joo Hyung LEE, Seongnam-si (KR)

(21) Appl. No.: 16/985,437

(22) Filed: Aug. 5, 2020

(51) Int. Cl. G05B 19/042; G06Q 10/06; G06Q 10/10; G06Q 50/06; H02J 3/32; G06Q 30/00; G06N 20/00; G06Q 30/02

(52) U.S. Cl. CPC G05B 19/042; G06Q 10/06315; G06Q 10/10; G06Q 50/06; G05B 2219/2639; H02J 3/32; G06Q 30/016; G06N 20/00; G06Q 30/0206; G06Q 10/06312

(57) ABSTRACT

The energy storage system operating apparatus and method includes a pre-optimization processing unit configured to generate an operating schedule, which is for operating the energy storage system during a set period, for each predetermined section by reflecting electric power billing environment data in at least one of a consumer policy and operating characteristics of the energy storage system and configured to set an electric power reserve to prepare for a shortage of an electric power amount; and an operating control unit configured to detect, for each section, an error between a value measured as being actually consumed and a predicted value of the operating schedule generated by the pre-optimization processing unit and configured to selectively reflect the electric power reserve in a discharging amount corresponding to the operating schedule in a subsequent section according to the detected error to control an energy storage system operating unit.

### FIELD OF TECHNOLOGY

The following relates to an apparatus and method for operating an energy storage system, and more particularly, to an energy storage system operating apparatus and method capable of operating an energy storage system based on a pricing plan applicable for each consumer, battery deterioration, and an error value of predicted electric power demand data in order to reduce consumer electric power bills.

### BACKGROUND

Large-scale batteries (energy storage system), which were used only for emergency power generation in buildings, are now used in various electric power business fields due to their excellent utility and low prices.

Considering the technological maturity and penetration rate of each battery, the battery capacity suitable for use from consumers' point of view is less than or equal to 10 MW. In particular, among such batteries, a lithium-ion battery (Li-ion battery) is most efficient because it has better stability and utility than other batteries and is less burdensome in terms of price.

Lithium-ion batteries are not only used to reduce electric power bills in factories and buildings but are also used in movable objects, for example, trams, electric vehicles, trains, etc., to replace existing energy sources.

However, as described above, there are still many factors to consider when applying lithium-ion batteries, which have excellent performance as described above, to actual environments. The Korean billing environment is divided into four representative pricing plans. In the case of a method of charging electric power bills based on the cumulative peak (the maximum peak load for one year), it is difficult to expect a cost reduction effect and the billing environment also involves the complexity of having to proceed with prior consultation with electric power companies even though an energy storage device is used. In addition, an applicable pricing plan is set differently depending on whether a smart meter is installed, and thus it is necessary to consider applicable pricing plans based on a thorough preliminary investigation. Moreover, even if there are cost savings, it is not easy to ignore the cost aspect of batteries. Even with a simple installation cost, $110 to $350 per kWh is incurred, and a maintenance cost of at least several hundred million Korean won is required. In addition, additional costs, such as maintenance costs, battery life, and the like, corresponding to temperature and other environments act as a burden for battery users.

The background of the present invention, which is hereby incorporated by reference, is disclosed in Korean Patent No. 10-1787538, published on Oct. 12, 2017 and entitled “Charging and discharging method of energy storage device based on uncertainty of demand load and apparatus thereof.”

### SUMMARY

An aspect relates to providing an energy storage system operating apparatus and method allowing a consumer's electric power bill to be reduced by operating the energy storage system on the basis of a pricing plan applicable for each consumer, battery degradation, and a predicted error of electric power demand data.

According to an aspect of embodiments of the present invention, there is provided an energy storage system operating apparatus including a pre-optimization processing unit configured to generate an operating schedule, which is for operating the energy storage system during a set period, for each predetermined section by reflecting electric power billing environment data in at least one of a consumer policy and operating characteristics of the energy storage system and configured to set an electric power reserve to prepare for a shortage of an electric power amount; and an operating control unit configured to detect, for each section, an error between a value measured as being actually consumed and a predicted value of the operating schedule generated by the pre-optimization processing unit and configured to selectively reflect the electric power reserve in a discharging amount corresponding to the operating schedule in a subsequent section according to the detected error to control an energy storage system operating unit.

The electric power billing environment data may include at least one of battery data regarding battery characteristics and battery degradation upon use, price data regarding a pricing plan applicable when operating the energy storage system, and a demand response (DR) signal that requests a reduction in the amount of use in a demand management market when the amount of supply and demand of electric power is unstable.

The price data may include at least one of a pricing plan which is applied according to the amount of use of electric power fixed for the amount of supply and demand of electric power in a system and a pricing plan in which an incentive is assigned to a predicted amount of decrease compared to a peak.

The electric power reserve may be set within an allowable range corresponding to the battery data.

The consumer policy may be set by a consumer and may include at least one of frequency stabilization, electric power supply and demand stabilization, and electric power bill reduction.

The pre-optimization processing unit may set a weighting value for each section by reflecting the electric power billing environment data in the consumer policy, and the operating control unit may adjust an available amount of the electric power reserve for each section according to the weighting value.

The operating control unit may include an error detection unit configured to detect and learn, for each section, the error between the predicted value of the operating schedule and the value measured as being actually consumed; an additional electric power amount prediction unit configured to predict an additional electric power amount to be allocated in a subsequent section on the basis of the electric power reserve according to a result of learning the error detected by the error detection unit; and an electric power operating unit configured to control operating of the energy storage system according to an additional electric power amount predicted by the additional electric power amount prediction unit.

The electric power operating unit may control the operating of the energy storage system and supply electric power according to the sum of the electric power amount of the operating schedule and the additional electric power amount predicted by the additional electric power amount prediction unit.

According to another aspect of embodiments of the present invention, there is provided an energy storage system operating method including a pre-optimization processing unit generating an operating schedule, which is for operating the energy storage system during a set period, for each predetermined section by reflecting electric power billing environment data in at least one of a consumer policy and operating characteristics of the energy storage system and setting an electric power reserve to prepare for a shortage of an electric power amount; and an operating control unit detecting, for each section, an error between a value measured as being actually consumed and a predicted value of the operating schedule generated by the pre-optimization processing unit and selectively reflecting the electric power reserve in a discharging amount corresponding to the operating schedule in a subsequent section according to the detected error to control an energy storage system operating unit.

The electric power billing environment data may include at least one of battery data regarding battery characteristics and battery degradation upon use, price data regarding a pricing plan applicable when operating the energy storage system, and a demand response (DR) signal that requests a reduction in the amount of use in a demand management market when the amount of supply and demand of electric power is unstable.

The price data may include at least one of a pricing plan which is applied according to the amount of use of electric power fixed for the amount of supply and demand of electric power in a system and a pricing plan in which an incentive is assigned to a predicted amount of decrease compared to a peak.

The electric power reserve may be set within an allowable range corresponding to the battery data.

The consumer policy may be set by a consumer and may include at least one of frequency stabilization, electric power supply and demand stabilization, and electric power bill reduction.

The method may further include the pre-optimization processing unit setting a weighting value for each section by reflecting the electric power billing environment data in the consumer policy and the operating control unit adjusting an available amount of the electric power reserve for each section according to the weighting value.

The controlling of the energy storage system operating unit may include an error detection unit detecting and learning, for each section, the error between the predicted value of the operating schedule and the value measured as being actually consumed; an additional electric power amount prediction unit predicting an additional electric power amount to be allocated in a subsequent section on the basis of the electric power reserve according to a result of learning the error detected by the error detection unit; and an electric power operating unit controlling operating of the energy storage system according to an additional electric power amount predicted by the additional electric power amount prediction unit.

The controlling of the operating of the energy storage system may include the electric power operating unit controlling the operating of the energy storage system to supply electric power according to the sum of the electric power amount of the operating schedule and the additional electric power amount predicted by the additional electric power amount prediction unit.

### BRIEF DESCRIPTION OF THE DRAWINGS

Some of the embodiments will be described in detail, with references to the following Figures, wherein like designations denote like members, wherein:

FIG. 1 is a block diagram of an energy storage system operating apparatus according to an embodiment of the present invention;

FIG. 2 is a diagram showing electric power billing environment data according to an embodiment of the present invention;

FIG. 3 is a diagram showing an error analysis of an error detection unit according to an embodiment of the present invention;

FIG. 4 is a diagram showing the operating of an electric power reserve by an electric power operating unit according to an embodiment of the present invention;

FIG. 5 is a diagram showing a decrease in the average amount of use of electric power through the operating of an electric power reserve in an actual electric power billing environment according to an embodiment of the present invention; and

FIG. 6 is a flowchart of an energy storage system operating method according to an embodiment of the present invention.

### DETAILED DESCRIPTION

Hereinafter, an apparatus and method for operating an energy storage system according to an embodiment of the present invention will be described in detail with reference to the accompanying drawings. In the drawings, thicknesses of lines or sizes of elements may be exaggerated for clarity and convenience. Also, the following terms are defined considering functions of embodiments of the present invention and may be differently defined depending on a user, the intent of an operator, or a custom. Therefore, the terms should be defined based on overall contents of the specification.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example an apparatus or a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, smartphones, tablets, computers, mobile phones, portable/personal digital assistants (PDAs), and other devices that facilitate communication of information between end-users.

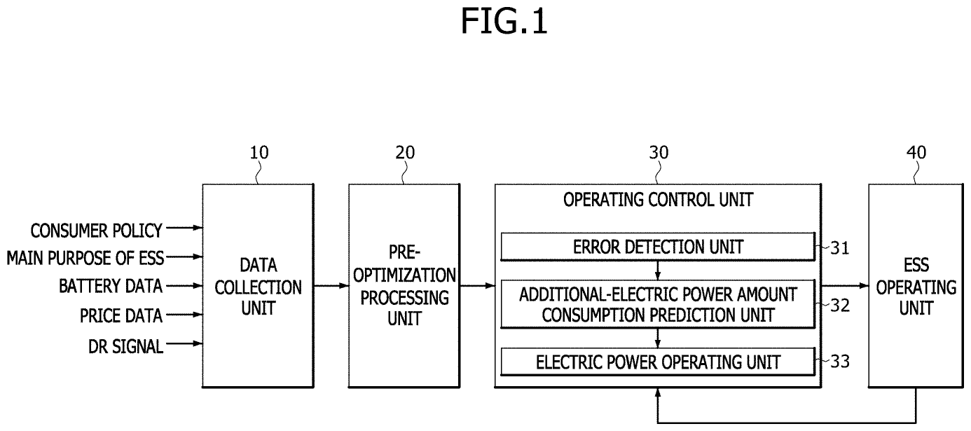

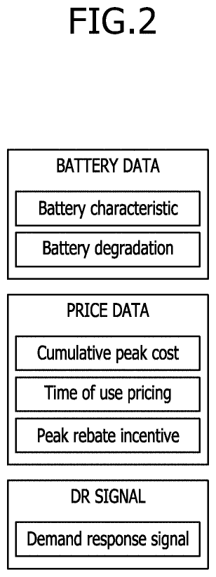

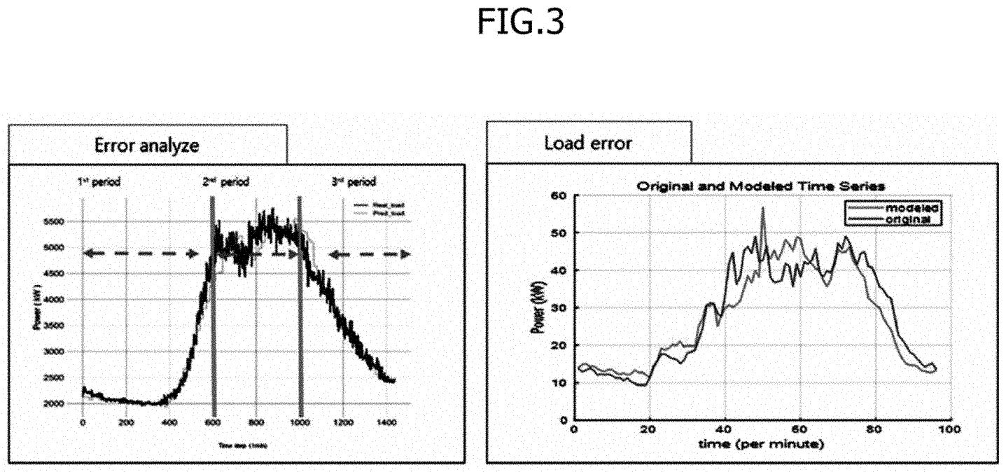

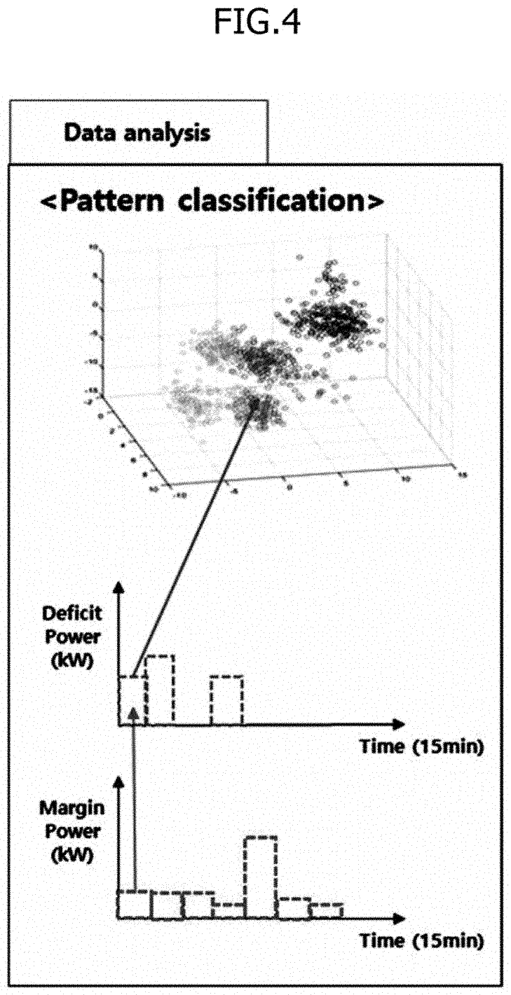

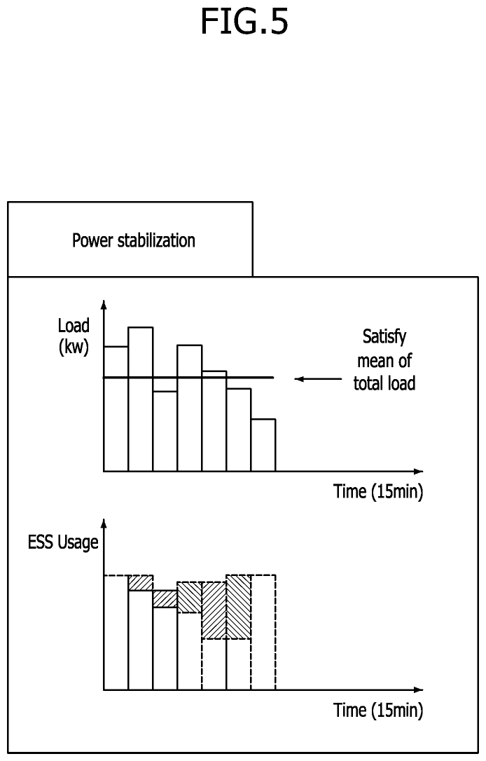

FIG. 1 is a block diagram of an energy storage system operating apparatus according to an embodiment of the present invention, FIG. 2 is a diagram showing electric power billing environment data according to an embodiment of the present invention, FIG. 3 is a diagram showing an error analysis of an error detection unit according to an embodiment of the present invention, FIG. 4 is a diagram showing the operating of an electric power reserve by an electric power operating unit according to an embodiment of the present invention, and FIG. 5 is a diagram showing a decrease in the average amount of use of electric power through the operating of an electric power reserve in an actual electric power billing environment according to an embodiment of the present invention.

Referring to FIG. 1, the energy storage system operating apparatus according to an embodiment of the present invention includes a data collection unit 10, a pre-optimization processing unit 20, an operating control unit 30, and an energy storage system (ESS) operating unit 40.

The data collection unit 10 collects consumer policy, the main purpose of the energy storage system, e.g., the operating characteristics of the energy storage system, and electric power billing environment data.

The consumer policy may be set by a consumer who operates the energy storage system and may include at least one of frequency stabilization, electric power supply and demand stabilization, and electric power bill reduction. Typically, a consumer operates an energy storage system according to whether he or she will reduce an electric power bill, whether he or she will decrease a peak load, etc.

Thus, the data collection unit 10 allows an energy operating method appropriate for an initial purpose of a consumer to be received by receiving at least one of frequency stabilization, electric power supply and demand stabilization, and electric power bill reduction from the consumer as the consumer policy.

The operating characteristics of the energy storage system may include capacitor characteristics, an operating scheme, or the like of the energy storage system. Referring to FIG. 2, the electric power billing environment data is data that can affect a consumer's electric power bill and may include battery data, price data, and a demand response (DR) signal.

The battery data is data corresponding to the characteristics of the battery itself as a necessary consideration factor to be considered basically for battery operation and may be preset upon purchasing or manufacturing a battery.

The battery data may include battery characteristic data and battery degradation data. The battery characteristic data may include battery temperature, maximum allowable capacity, and the like, and the battery degradation data is data indicating degradation information due to battery use.

The price data is data regarding a pricing plan that can generate profits when operating the energy storage system in consideration of a consumer's electric power billing environment and may be collected from a power exchange.

The price data may include a cumulative peak cost plan, a time-of-use pricing plan, and a peak rebate incentive plan.

The time-of-use pricing plan may be a pricing plan which is applied to the fixed amount of use of electric power for the amount of supply and demand of electric power in a system by season or time.

The peak rebate incentive plan is a pricing plan in which an incentive is applied for a predicted amount of reduction from a peak from an electric power company's standpoint.

The DR signal is a signal that requests participants who participated in a demand management market to reduce usage when the amount of supply and demand of electric power in a system is unstable and may be received from an electric power company.

The pre-optimization processing unit 20 generates an operating schedule, which is for operating the energy storage system during a set period, for each predetermined section by reflecting electric power billing environment data in at least one of the operating characteristics of the energy storage system and the consumer policy and set an electric power reserve to prepare for a shortage of an electric power amount.

Here, the section may be set in the range of one to fifteen minutes by considering that an electric power bill in the pricing plan is typically offset based on the average amount of use of electric power every 15 minutes.

That is, the pre-optimization processing unit 20 analyzes a consumer's electric power bill and electric power environment using the consumer policy, the operating characteristics of the energy storage system, and the electric power billing environment data, analyzes battery characteristics and states, and, in addition, derives profits obtainable when participating in the market according to the DR signal and the pricing plan during the set period, e.g., one day in advance to pre-generate an operating schedule based on the consumer's electric power bill and electric power environment, the battery characteristics and states, and the profits.

The operating schedule is information regarding a scheme of operating the energy operating system for a set period and may include the amount of electric power to be supplied through the energy operating system for each predetermined section.

Since the operating schedule is set one day in advance as described above, the operating control unit 30 actually controls the energy operating system on the basis of the operating schedule on the day after the operating schedule is set.

Also, the pre-optimization processing unit 20 sets an electric power reserve for operating the energy storage system during the set period by reflecting the electric power billing environment data in at least one of the consumer policy and the operating characteristics of the energy storage system as described above.

The electric power reserve is the amount of electric power to be additionally supplied in preparation for a sudden increase in power consumption that may occur due to system instability or battery degradation when operating the energy operating system.

The electric power reserve may be set within an allowable range corresponding to the battery data, and to this end, the battery data may include the total amount of battery capacity, the maximum amount of battery charging or discharging, or the like.

By setting the electric power reserve in advance as described above, electric power may be additionally supplied when an error occurs between a predicted value of the operating schedule and a value measured as being actually consumed, and it is also possible to efficiently operate the energy storage system for each section.

Moreover, the pre-optimization processing unit 20 determines a weighting value depending on a bill and a discharging amount for each section. The weighting value may be set for a corresponding section when the electric power bill is applied repeatedly by time slot.

The weighting value may enable an available electric power reserve to be adjusted for each section, and thus it is possible to solve a shortage of power supply even if the error between the predicted value and the measured value is relatively high.

The operating control unit 30 detects, for each section, the error between the value measured as being actually consumed and the predicted value of the operating schedule generated by the pre-optimization processing unit 20 and selectively reflects an electric power reserve in the discharging amount (the amount of electric power) corresponding to the operating schedule in the next section according to the error so as to control the ESS operating unit 40.

The operating control unit 30 may include an error detection unit 31, an additional electric power amount prediction unit 32, and an electric power operating unit 33.

The error detection unit 31 detects and learns the error between the predicted value of the operating schedule and the value measured as being actually consumed for each section.

That is, the error detection unit 31 may detect and record the error between the predicted value and the measured value through a real-time analysis of a value predicted in advance and an additionally incoming value measured as being actually consumed, as shown in FIG. 3. Also, the error detection unit 31 may assign the weighting value according to the error value in consideration of the electric power bill for each section. The value measured as being currently consumed may be detected by the ESS operating unit 40.

The additional electric power amount prediction unit 32 predicts an additional electric power amount to be allocated in the next section on the basis of the electric power reserve according to a result of learning the error detected by the error detection unit 31.

The electric power operating unit 33 controls the ESS operating unit 40 according to the additional electric power amount predicted by the additional electric power amount prediction unit 32 to control the operating of the energy storage system. That is, the electric power operating unit 33 controls the operating of the energy storage system to supply electric power according to the sum of the electric power amount of the operating schedule and the additional electric power amount predicted by the additional electric power amount prediction unit 32.

Referring to FIG. 4, the electric power reserve may be supplied in consideration of the features of the pricing plan that is offset based on the average amount of use of electric power in every section, for example, every one minute, and an error updated during the corresponding section.

In this case, when a weight value is smaller than a predetermined value, the electric power operating unit 33 may decrease the amount of error removal by supplying a relatively small electric power reserve in a corresponding section.

On the other hand, when a weighting value is greater than a predetermined value, the electric power operating unit 33 may solve a shortage of electric power due to a relatively large error by supplying a relatively high electric power reserve.

Furthermore, the electric power operating unit 33 limits the amount of electric power to the electric power reserve allocated to each section, and thus it is possible to reduce an electric power bill generated in a corresponding section.

That is, as shown in FIG. 5, the electric power operating unit 33 may decrease the average amount of use of electric power by operating the electric power reserve in an actual electric power billing environment.

For example, the time-of-use pricing plan is a pricing plan in which an electric power bill is applied on an hourly basis and may reduce an electric power bill by reducing the average amount of electric power per one minute.

Also, the base rate and peak rebate pricing plan is a pricing plan in which an electric power bill is offset based on the average amount of use of electric power every 15 minutes and may reduce an electric power bill by reducing the average amount of electric power per one minute.

The ESS operating unit 40 operates the energy storage system according to a control signal of the electric power operating unit 33 and may obtain the above-described reduction of the electric power bill by supplying the sum of the amount of electric power of the operating schedule and the additional electric power amount predicted by the additional electric power amount prediction unit 32 to a consumer according to the control signal input from the electric power operating unit 33.

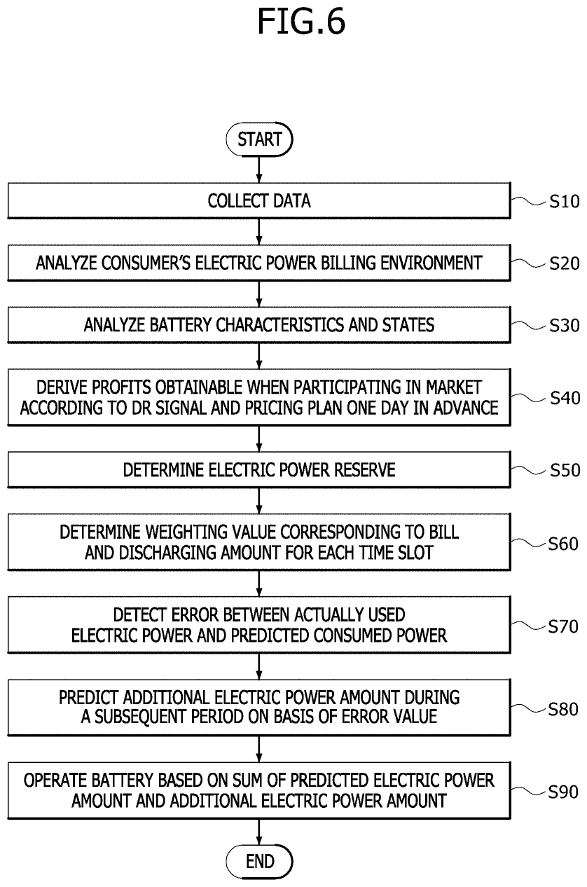

A method of operating an energy storage system according to an embodiment of the present invention will be described below in detail with reference to FIG. 6.

FIG. 6 is a flowchart of an energy storage system operating method according to an embodiment of the present invention.

Referring to FIG. 6, first, the data collection unit 10 collects consumer policy, the operating characteristics of the energy storage system, i.e., the main purpose of the energy storage system, and electric power billing environment data (S10).

Here, the consumer policy may be set by a consumer who operates the energy storage system and may include at least one of frequency stabilization, electric power supply and demand stabilization, and electric power bill reduction, and the operating characteristics of the energy storage system may include capacitor characteristics, an operating scheme, or the like of the energy storage system. Also, the electric power billing environment data is data that can affect a consumer's electric power bill and may include battery data, price data, and a DR signal.

When data is collected by the data collection unit 10, the pre-optimization processing unit 20 analyzes a consumer's electric power bill and electric power environment using the consumer policy, the operating characteristics of the energy storage system, and the electric power billing environment data, analyzes battery characteristics and states, and, in addition, derives profits obtainable when participating in the market according to the DR signal and the pricing plan during the set period, e.g., one day in advance, (S20, S30, S40) to pre-generate an operating schedule based on the consumer's electric power bill and electric power environment, the battery characteristics and states, and the profits.

Subsequently, the pre-optimization processing unit 20 sets an electric power reserve for operating the energy storage system during the set period by reflecting the electric power billing environment data in at least one of the consumer policy and the operating characteristics of the energy storage system (S50). Here, the electric power reserve is the amount of electric power to be additionally supplied in preparation for a sudden increase in power consumption that may occur due to system instability or battery degradation when operating the energy operating system.

Also, the pre-optimization processing unit 20 determines a weighting value depending on a bill and a discharging amount for each section.

When, as described above, the operating schedule, the electric power reserve, and the weighting value are set by the pre-optimization processing unit 20, the error detection unit 31 detects an error between a predicted value and a measured value through a real-time analysis of a value predicted in advance and an additionally incoming value measured as being actually consumed (S70) and records the detected error.

In this case, the error detection unit 31 may assign the weighting value depending on the error value in consideration of the electric power bill for each section.

Subsequently, the additional electric power amount prediction unit 32 predicts an additional electric power amount to be allocated in the next section on the basis of the electric power reserve according to a result of learning the error detected by the error detection unit 31 (S80).

Since the additional electric power amount is predicted by the additional electric power amount prediction unit 32, the electric power operating unit 33 controls the ESS operating unit 40 according to the sum of the electric power amount of the operating schedule and the additional electric power amount predicted by the additional electric power amount prediction unit 32 so that the batter can be operated according to the electric power amount (S90).

As described above, the energy storage system operating apparatus and method according to an embodiment of the present invention can reduce a consumer's electric power bill by operating the energy storage system on the basis of a pricing plan applicable for each consumer, battery degradation, and a predicted error of electric power demand data.

Also, the energy storage system operating apparatus and method according to an embodiment of the present invention can contribute to the expansion of the energy storage system in the market by inducing a consumer's electric power bill to be reduced.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

What is claimed is:

1. An apparatus for operating an energy storage system, the apparatus comprising:
a pre-optimization processing unit configured to generate an operating schedule, which is for operating the energy storage system during a set period, for each predetermined section by reflecting electric power billing environment data in at least one of a consumer policy and operating characteristics of the energy storage system and configured to set an electric power reserve to prepare for a shortage of an electric power amount; and
an operating control unit configured to detect, for each section, an error between a value measured as being actually consumed and a predicted value of the operating schedule generated by the pre-optimization processing unit and configured to selectively reflect the electric power reserve in a discharging amount corresponding to the operating schedule in a subsequent section according to the detected error to control an energy storage system operating unit.

2. The apparatus of claim 1, wherein the electric power billing environment data comprises at least one of battery data regarding battery characteristics and battery degradation upon use, price data regarding a pricing plan applicable when operating the energy storage system, and a demand response signal that requests a reduction in the amount of use in a demand management market when the amount of supply and demand of electric power is unstable.

3. The apparatus of claim 2, wherein the price data comprises at least one of a pricing plan which is applied according to the amount of use of electric power fixed for the amount of supply and demand of electric power in a system and a pricing plan in which an incentive is assigned to a predicted amount of decrease compared to a peak.

4. The apparatus of claim 2, wherein the electric power reserve is set within an allowable range corresponding to the battery data.

5. The apparatus of claim 1, wherein the consumer policy is set by a consumer and comprises at least one of frequency stabilization, electric power supply and demand stabilization, and electric power bill reduction.

6. The apparatus of claim 1, wherein the pre-optimization processing unit sets a weighting value for each section by reflecting the electric power billing environment data in the consumer policy, and the operating control unit adjusts an available amount of the electric power reserve for each section according to the weighting value.

7. The apparatus of claim 1, wherein the operating control unit comprises:
an error detection unit configured to detect and learn, for each section, the error between the predicted value of the operating schedule and the value measured as being actually consumed;
an additional electric power amount prediction unit configured to predict an additional electric power amount to be allocated in a subsequent section on the basis of the electric power reserve according to a result of learning the error detected by the error detection unit; and
an electric power operating unit configured to control operating of the energy storage system according to an additional electric power amount predicted by the additional electric power amount prediction unit.

8. The apparatus of claim 7, wherein the electric power operating unit controls the operating of the energy storage system to supply electric power according to the sum of the electric power amount of the operating schedule and the additional electric power amount predicted by the additional electric power amount prediction unit.

9. A method of operating an energy storage system, the method comprising:
a pre-optimization processing unit generating an operating schedule, which is for operating the energy storage system during a set period, for each predetermined section by reflecting electric power billing environment data in at least one of a consumer policy and operating characteristics of the energy storage system and setting an electric power reserve to prepare for a shortage of an electric power amount; and
an operating control unit detecting, for each section, an error between a value measured as being actually consumed and a predicted value of the operating schedule generated by the pre-optimization processing unit and selectively reflecting the electric power reserve in a discharging amount corresponding to the operating schedule in a subsequent section according to the detected error to control an energy storage system operating unit.

10. The method of claim 9, wherein the electric power billing environment data comprises at least one of battery data regarding battery characteristics and battery degradation upon use, price data regarding a pricing plan applicable when operating the energy storage system, and a demand response signal that requests a reduction in the amount of use in a demand management market when the amount of supply and demand of electric power is unstable.

11. The method of claim 10, wherein the price data comprises at least one of a pricing plan which is applied according to the amount of use of electric power fixed for the amount of supply and demand of electric power in a system and a pricing plan in which an incentive is assigned to a predicted amount of decrease compared to a peak.

12. The method of claim 10, wherein the electric power reserve is set within an allowable range corresponding to the battery data.

13. The method of claim 9, wherein the consumer policy is set by a consumer and comprises at least one of frequency stabilization, electric power supply and demand stabilization, and electric power bill reduction.

14. The method of claim 9, further comprising the pre-optimization processing unit setting a weighting value for each section by reflecting the electric power billing environment data in the consumer policy, and the operating control unit adjusting an available amount of the electric power reserve for each section according to the weighting value.

15. The method of claim 9, wherein the controlling of the energy storage system operating unit comprises:
an error detection unit detecting and learning, for each section, the error between the predicted value of the operating schedule and the value measured as being actually consumed;
an additional electric power amount prediction unit predicting an additional electric power amount to be allocated in a subsequent section on the basis of the electric power reserve according to a result of learning the error detected by the error detection unit; and
an electric power operating unit controlling operating of the energy storage system according to an additional electric power amount predicted by the additional electric power amount prediction unit.

16. The method of claim 15, wherein the controlling of the operating of the energy storage system comprises the electric power operating unit controlling the operating of the energy storage system to supply electric power according to the sum of the electric power amount of the operating schedule and the additional electric power amount predicted by the additional electric power amount prediction unit.
